(19) United States
(12) Patent Application Publication
(10) Pub. No.: US 2024/0425393 A1
(43) Pub. Date: Dec. 26, 2024

(54) DEVICE AND METHOD FOR TREATING AN AQUEOUS LIQUID

(71) Applicant: MITTEMITTE GMBH, Berlin (DE)

(72) Inventors: Wiebe Wagemans, Berlin (DE); Thiebaut KIENTZ, Berlin (DE); Benjamin PARDOWITZ, Berlin (DE); Agnieszka CZESZUMSKA, Berlin (DE)

(73) Assignee: mittemitte GmbH, Berlin (DE)

(21) Appl. No.: 18/262,737

(22) PCT Filed: Jan. 26, 2022
(86) PCT No.: PCT/EP2022/051796

§ 371 Date: Jul. 25, 2023

(30) Foreign Application Priority Data
Jan. 26, 2021 (EP) 21153620.6
Jun. 4, 2021 (EP) 21177880.8

(51) Int. Cl. C02F 1/68; A23L 2/54; B01F 23/236; B01F 23/2361; B01F 23/237; B01F 101/14

(52) U.S. Cl. CPC C02F 1/685; A23L 2/54; B01F 23/2361; B01F 23/2363; B01F 23/237621; B01F 2101/14; C02F 2201/005; C02F 2209/38

(57) ABSTRACT

The invention relates to a device for treating an aqueous liquid. The device comprises a gas providing unit (10) and a first gas line (20) connecting the gas providing unit (10) and a first liquid container (50), such that liquid residing in the first liquid container (50) can be pre-conditioned. The device comprises a conditioning unit (70) and a fluid line (40), wherein a first section of the fluid line (42) connects the first liquid container (50) and the conditioning unit (70). A second section of the fluid line (44) connects the conditioning unit (70) and the second liquid container (52). The device comprises a second gas line (28) connecting the gas providing unit (10) and the second liquid container (52), such that the gas is feedable in the second liquid container (52). The device is configured such that the gas is feedable in the liquid upstream of the conditioning unit (70) via the first gas line (20) and downstream of the conditioning unit (70) via the second gas line (28).

The invention relates to a device and a method for treating an aqueous liquid, particularly priming, mineralising, and/or carbonating an aqueous liquid. The aqueous liquid can be a beverage, particularly drinking water.

To produce carbonated mineralized water from tap water, it is necessary to add minerals and to add CO₂ to the water. Mineralisation can be done by dissolving appropriate salts while water is passing through a packing of mineral grains. Dissolution in tap water is difficult and can be improved by acidifying the water before flowing it through the packing. Various acidification techniques exist such as mixing a liquid acid to the water or dissolving a solid acid compound into it. It is also known to inject gaseous CO₂ in the water to make it more acidic (process also referred to as “priming” in this document).

“Carbonation” (i.e. making water sparkling) is done by mixing CO₂ and water, for example by injecting pressurised gaseous CO₂ in water. The carbonation can happen in a closed volume prior to dispensing (e.g. Kärcher WPD, Sodax), or in the dispense line (e.g. Rotarex “BubbleBox”), or in the bottle filled with water (e.g. Sodastream, Aarke).

The invention disclosed here can be applied to each of those methods.

Devices for carbonating aqueous liquids by adding gaseous CO₂ are known from the prior art. Furthermore, devices are known for mineralisation of the aqueous liquid by adding mineral salts (US 2017/0000164 A1). It is known that mineralisation can be improved when the aqueous liquid is acidified prior to mineralisation (e.g. US 2018 370 826, US 2019 144 311). Acidification can be realised by adding a small amount of CO₂ to the aqueous liquid.

The objective underlying the present invention is to provide an improved device configured for treating an aqueous liquid. In particular, the objective underlying the present invention is to provide a device for pre-conditioning the aqueous liquid prior to mineralisation and carbonating post mineralisation.

This objective is attained by the subject matter of the independent claims. Favorable embodiments are claimed in the sub claims and described hereafter.

A first aspect of the invention is a device for treating an aqueous liquid, comprising a gas providing unit, providing a gas at a first pressure, a first gas line connecting the gas providing unit and a first liquid container, such that the gas is feedable in the first liquid container via the first gas line, such that when the first liquid container contains the aqueous liquid, the aqueous liquid can be pre-conditioned. Further, the device comprises a conditioning unit and a fluid line connecting the first liquid container with a second liquid container, when the second liquid container is provided, wherein the fluid line comprises a first section and a second section, wherein the first section of the fluid line connects the first liquid container and the conditioning unit and the second section of the fluid line connects the conditioning unit and the second liquid container. The device comprises a second gas line connecting the gas providing unit and the second liquid container, when the second liquid container is provided, such that the gas is feedable in the second liquid container via the second gas line, such that when the second liquid container contains the aqueous liquid, particularly the aqueous liquid previously pre-conditioned in the first liquid container, the gas can be injected in the aqueous liquid, wherein the device is arranged and configured such that the gas is feedable in the aqueous liquid upstream of the conditioning unit via the first gas line and downstream of the conditioning unit via the second gas line.

The aqueous liquid can be a beverage, particularly drinking water.

In an embodiment, the device comprises an input section for providing the aqueous liquid to the device. The input section can be connected fluidically with the first liquid container.

The gas providing unit can comprise a gas cartridge. In an embodiment, the gas is CO₂.

The first liquid container can be a tank. The first liquid container can be a reservoir, particularly a liquid reservoir. In an embodiment, the first liquid container is a section of a line, particularly a section of a fluid line. In an embodiment, the first liquid container is a T-junction of a fluid line.

The first liquid container can comprise an inner space of the first liquid container. In an embodiment, the first liquid container is arranged and configured such that the aqueous liquid is arrangeable in the first liquid container, particularly in the inner space of the first liquid container.

In an embodiment, the first liquid container is arranged and configured such that the aqueous liquid can rest in the first liquid container, in particular in the inner space of the first liquid container. According to an embodiment, the device is arranged and configure such that the aqueous liquid can rest in the first liquid container, particularly its inner space, while the aqueous liquid is pre-conditioned.

According to an embodiment, the device is arranged and configured such that the aqueous liquid flows through the first liquid container, particularly the inner space of the first liquid container, while the aqueous liquid is pre-conditioned.

According to an embodiment, the first liquid container is arranged and configured such that the aqueous liquid flows through the first liquid container, particularly the inner space of the first liquid container, while the aqueous liquid is pre-conditioned.

Pre-conditioning can be the acidification of the aqueous liquid. Pre-conditioning can be the priming of the aqueous liquid.

For acidification or priming, a low amount of CO₂ can be fed into the aqueous liquid. In an embodiment, a mass of CO₂ is fed into the aqueous liquid for priming in the range of 0.2 g/l to 2 g/l, particularly in the range of 0.3 g/l to 1 g/l.

The second liquid container can be configured for the uptake and/or storage of the aqueous liquid. The second liquid container can comprise an inner space of the second liquid container. In particular, the inner space of the second liquid container can be configured for the uptake and/or storage of the aqueous liquid.

The second liquid container can be a bottle. In an embodiment, the second liquid container is a glass. In an embodiment, the second liquid container is a tank. The second liquid container can be a jug. According to an embodiment, the second liquid container is a canister. In an embodiment, the second liquid container is a section of a line, particularly a section of a fluid line. In an embodiment, the first liquid container is a T-junction.

The second liquid container can be provided to the device. In an embodiment, the second liquid container can be inserted in the device. The device can comprise a receiving unit configured to receive the second liquid container. In an embodiment, the second liquid container is removable from the device.

In an embodiment, the fluid line fluidically connects the first liquid reservoir and the second liquid reservoir. In an embodiment, the fluid line is configured and arranged to connect, particularly connect fluidically, the inner space of the first liquid container and the inner space of the second liquid container.

The fluid line can be configured and arranged such that aqueous liquid can flow from the first liquid reservoir to the second liquid reservoir via the fluid line. Particularly, the device can be configured such that aqueous liquid pre-conditioned in the first liquid container can flow from the first liquid reservoir to the second liquid reservoir via the fluid line.

The fluid line comprises a first section and a second section. The first section of the fluid line can connect fluidically the first liquid container and the conditioning unit. The second section of the fluid line can fluidically connect the conditioning unit and the second liquid container.

According to an embodiment, the conditioning unit is comprised in the fluid line, particularly between the first section of the fluid line and the second section of the fluid line.

The device can be configured and arranged such that through the fluid line, the aqueous liquid can flow from the first liquid container via the conditioning unit to the second liquid container.

In an embodiment, the device is arranged and configured such that when the aqueous liquid is provided to the device, the aqueous liquid can flow from the input section to the first liquid container and from the first liquid container to the second liquid container via the conditioning unit.

The device is arranged and configured such that via the first gas line the gas is feedable in the aqueous liquid upstream of the conditioning unit. The device can be arranged and configured such that via the first gas line the gas is feedable in the aqueous liquid before the aqueous liquid is moved to the conditioning unit. In the context of the application, the wording upstream means closer to a particular source. With respect to the flow of the aqueous liquid, upstream means closer to the input section.

The device is arranged and configured such that via the second gas line the gas is feedable in the aqueous liquid downstream of the conditioning unit. The device can be arranged and configured such that via the second gas line the gas is feedable in the aqueous liquid after the aqueous liquid has passed the conditioning unit. In the context of the application, the wording downstream means distant to a particular source. With respect to the flow of the aqueous liquid, downstream means distant to the input section.

In an embodiment, a branching line is required to supply CO₂ to the water prior to mineralisation.

According to an embodiment, the device is configured and arranged such that the aqueous liquid is pre-conditioned before entering the conditioning unit. According to an embodiment, the device is configured and arranged such that the aqueous liquid is carbonated after leaving the conditioning unit. The aqueous liquid can be carbonated in the second liquid container.

According to an embodiment, the device is configured such that the second liquid container is fed with gas via the second gas line, such that when the second liquid container contains the aqueous liquid, particularly the aqueous liquid previously pre-conditioned in the first liquid container, the aqueous liquid can be carbonated.

For carbonation, a high amount of CO₂ can be fed into the aqueous liquid. In an embodiment, a mass of CO₂ is fed into the aqueous liquid in the range of 5 g/l to 35 g/l, particularly in the range of 8 g/l to 20 g/l. By carbonation, sparkling aqueous liquid, particularly sparkling water, can be generated.

In an embodiment, the gas providing unit is used for pre-conditioning the aqueous liquid in the first liquid container, particularly acidifying the aqueous liquid in the first liquid container, and to treat the aqueous liquid in the second liquid container, particularly carbonate the aqueous liquid previously pre-treated in the first liquid container. The device can comprise a single source of CO₂ to first acidify and later carbonate the water. The device can incorporate a source of pressurised CO₂ which could be used to acidify the water prior to flowing through the minerals.

The device can be configured and arranged to feed a low amount of CO₂ in the aqueous liquid before the liquid passes the conditioning unit and a high amount of CO₂ after passing the conditioning unit. The device can be configured and arranged to feed a low amount of CO₂ in the aqueous liquid upstream of the conditioning unit and a high amount of CO₂ downstream of the conditioning unit. Thereby, in addition to be acidified, the aqueous liquid can also be p re-carbonated

In an embodiment, the first gas line is connected with the gas providing unit. In an embodiment, the second gas line is connected with the gas providing unit. According to an embodiment, the first gas line and the second gas line are connected with the gas providing unit via a shared gas line. In an embodiment, the first gas line and the second gas line branch off the shared gas line.

In an embodiment, the device is configured and arranged such that the gas providing unit can be used to acidify the aqueous liquid and to carbonate the aqueous liquid.

An advantage of the invention is that due to pre-conditioning the aqueous liquid, particularly acidifying the aqueous liquid, conditioning the aqueous liquid via the conditioning unit is enhanced.

An advantage of the invention is one common gas providing unit can be used for both purposes, for pre-conditioning the aqueous liquid, particularly priming the aqueous liquid, and for carbonating the aqueous liquid. Only one common gas providing unit is required such that the size of the device can be small which is advantageous for domestic purposes.

According to an embodiment, the gas providing unit comprises a gas reservoir containing a pressurised gas at a second pressure and a pressure reducer connected with the gas reservoir, wherein the pressure reducer is configured to reduce the pressure from the second pressure to the first pressure, such that the gas providing unit provides the gas at the first pressure.

The pressure reducer is configured to reduce the pressure from the second pressure to the first pressure. The pressure reducer can be associated with the source of gaseous CO₂ and can be adapted to supply gaseous CO₂ at a first pressure lower than the second pressure.

The pressure reducer can be fluidically connected with the gas reservoir. The gas reservoir can be a gas cartridge.

The pressurised gas can particularly be CO₂.

In an embodiment, the second pressure is at least as high as the first pressure.

According to an embodiment, the first pressure is smaller than 20 bar, particularly smaller than 15 bar, particularly smaller than 12 bar, particularly smaller than 10 bar.

According to an embodiment, the first pressure is greater than 0.5 bar, particularly greater than 1 bar, particularly greater than 2 bar.

According to an embodiment, the second pressure is greater than 10 bar, particularly greater than 20 bar, particularly greater than 30 bar, particularly greater than 40 bar, particularly greater than 40 bar, particularly greater than 50 bar.

According to an embodiment, the second pressure is smaller than 70 bar. According to an embodiment, the second pressure is 56 bar at room temperature.

The second pressure can decrease over time when the gas providing unit is in use.

The first gas line can fluidically connect the pressure reducer to the first liquid container, particularly a first flow or a volume of water, for mixing gaseous CO₂ with said water, thereby acidifying it. The second gas line can fluidically connect the pressure reducer to the second liquid container, particularly a second flow or volume of water adapted to inject gaseous CO₂ within said water.

The device can be configured and arranged such that the gas at first pressure can be inserted in the first gas line, particularly such that gas at the first pressure can be used for priming the aqueous liquid in the first liquid container.

The device can be configured and arranged such that the gas at first pressure can be inserted in the second gas line, particularly such that gas at the first pressure can be used for carbonating the aqueous liquid in the second liquid container.

Particularly, the device can be configured and arranged such that gas at first pressure can be inserted in the first gas line and in the second gas line, particularly such that gas at the first pressure can be used for priming of the aqueous liquid in the first liquid container and for carbonating the aqueous liquid in the second liquid container.

The pressure reducer can be a pressure reducing valve.

In an embodiment, the pressure reducer is configured to keep the first pressure constant when the second pressure is greater than a pre-defined threshold.

The pressure reducer can reduce the pressure such that the control of a low amount or low mass of CO₂ can be provided, which particularly is necessary for priming (acidification). The control of the low amount or low mass of CO₂, is difficult when dealing with high pressure. At high pressure, a valve opening event can release a large amount of CO₂.

Advantageously, at a lower pressure, the amount of gas fed in the aqueous liquid, particularly the amount fed in the aqueous liquid for priming, can be easily regulated.

In an embodiment, the device comprises at least one valve, wherein the at least one valve is arranged and configured to open and/or to close the first gas line and/or the second gas line, particularly wherein the at least one valve is a low-pressure valve.

In an embodiment, the device comprises at least one valve, wherein the at least one valve is arranged and configured to open and/or to close the first gas line, particularly wherein the at least one valve is a low-pressure valve.

In an embodiment, the device comprises at least one valve, wherein the at least one valve is arranged and configured to open and/or to close the second gas line, particularly wherein the at least one valve is a low-pressure valve.

In an embodiment, the device comprises at least one valve, wherein the at least one valve is arranged and configured to open and/or to close the first gas line and the second gas line, particularly wherein the at least one valve is a low-pressure valve.

Advantageously, a low-pressure valve is cheaper than a high-pressure valve such that the costs of the device are reduced. A low-pressure valve can be smaller in size and less bulky than a high-pressure valve. The overall size of the device can be reduced which can be advantageously for domestic use.

According to an embodiment, the device comprises a first flow control unit, wherein the first flow control unit is configured to regulate the amount of gas passing the first gas line.

The first flow control unit can be configured to control and/or to regulate the amount of gas passing the first gas line.

In an embodiment, the first gas line comprises a first section and a second section, wherein the first flow control unit connects the first section of the first gas line and the second section of the first gas line.

The first flow control unit can be configured to regulate the amount of gas moving from the first section of the first gas line to the second section of the first gas line.

The first flow control unit can be configured to regulate the amount of gas flowing from the gas providing unit to the first liquid reservoir via the first gas line, particularly the amount of gas entering the first liquid reservoir for pre-conditioning the aqueous liquid in the first liquid reservoir. The first flow control unit can be configured to regulate the amount of gas used for priming.

By means of the first flow control unit a known volume of gas, particularly CO₂, can be inserted in the first liquid reservoir, particularly for priming the aqueous liquid. The device can be configured such that a known volume of gas, particularly CO₂, to be mixed with aqueous liquid in first liquid reservoir.

The first flow control unit can be configured to control the amount of gas, particularly CO₂, necessary for acidification of aqueous liquid. The first flow control unit can be configured to regulate the feeding of the gas into the first liquid reservoir, particularly for pre-conditioning, particularly priming, the aqueous liquid.

Advantageously, via the first flow control unit the amount of gas required for priming can easily be regulated, particularly such that the aqueous liquid is acidified such that downstream conditioning in facilitated.

The first flow control unit can be regulated by a first control unit. The first flow control unit can be controlled by a first control unit.

For priming, lower amount of CO₂ is required compared to the amount of CO₂ required for carbonating, particularly bubbling up, the aqueous liquid.

In an embodiment, the first flow control unit comprises a storage section configured to store a predefined volume of gas, wherein the storage section comprises an entrance and an exit, wherein the entrance and/or the exit are configured to be opened and/or closed.

The storage section can comprise an inner space of the storage section. The inner space of the storage section can be configured to store the predefined volume of gas.

The exit can be arranged at the opposing end of the predefined section than the entrance. The entrance can be arranged closer to the gas providing unit than the exit. The exit can be arranged more distant to the gas providing unit than the entrance. The exit can be arranged closer to the first liquid reservoir than the entrance. In the context of the first fluid line, the entrance of the storage section can be arranged upstream of the exit of the storage section.

The pre-defined volume of gas can be the volume of gas required for priming.

The pre-defined volume of gas can be a portion of the volume of gas required for priming. The storage section can be configured such that the amount of CO₂ required for priming can be stored in the storage section. The storage section can be configured such that a portion of the amount of CO₂ required for priming can be stored in the storage section.

The device can be configured such that a pre-defined number of portions of the amount of CO₂ can be delivered to the first liquid container. The pre-defined number of portions can easily be adapted according to the required amount or volume of CO₂. The volume of CO₂ required can be dependent on the volume of aqueous liquid to be primed. The volume of CO₂ required can depend on the downstream conditioning process.

In an embodiment, the device is configured such that the pre-defined volume of gas can be added sequentially multiple times to the first liquid container. The gas can be fed multiple times to the first liquid container at equal, i.e. regular, time intervals. In an embodiment, the device is configured such that gas is injectable in the first liquid container 15 times, wherein the time interval between two successive injections is 2 seconds.

In an embodiment, the first liquid container is a T-junction, wherein the device is configured such that the aqueous liquid can flow through the T-junction. The device can be configured such that the flow of the aqueous liquid through the T-junction and the injection of gas in the T-junction are coordinated with each other. For a given amount of aqueous liquid to be pre-conditioned and flowing through the first liquid container, the pre-defined volume of gas can be added sequentially during the flow, such that, in total, the required amount of gas has been mixed with the aqueous liquid.

In an embodiment, the device is configured such that during the time aqueous liquid is flowing through the first liquid container, particularly through the T-junction, the pre-defined volume of gas would be added fifteen times, particularly fifteen times at regular intervals.

In an embodiment, the volume of the storage section is between 0.8 cm³ to 1.2 cm³, particularly 1 cm³. The storage section can be configured to store a mass of CO₂ in the range of 10 mg to 30 mg.

Via the storage section, the amount and/or the mass of CO₂ fed into the aqueous liquid for priming can easily be regulated. A loss of CO₂ due to injection of too much CO₂ for priming is advantageously reduced.

According to an embodiment, the first flow control unit comprises at least one pre-conditioning valve, wherein the at least one pre-conditioning valve is configured to open and/or close the first gas line, in particular configured to open and/or close the entrance and/or the exit of the storage section.

The at least one pre-conditioning valve can be a normally-closed valve. The at least one pre-conditioning valve can be a low-pressure valve. The at least one pre-conditioning valve can be regulatable. The at least one pre-conditioning valve can be controllable.

The at least one pre-conditioning valve can be configured to be in an open state and in a closed state.

The at least one pre-conditioning valve can be regulated by a first control unit. The at least one pre-conditioning valve can be controlled by a first control unit.

The at least one pre-conditioning valve can be arranged at the entrance of the storage section. The at least one pre-conditioning valve can be configured to control and/or to regulate the amount of gas entering the storage section.

The at least one pre-conditioning valve can be arranged at the exit of the storage section. The at least one pre-conditioning valve can be configured to control and/or regulate the amount or the volume of gas leaving the storage section.

The at least one pre-conditioning valve can be configured to open and/or close the first gas line such that via the at least one pre-conditioning valve the amount or the mass of gas passing the first gas line can be controlled or regulated. The supply of gas in the first liquid reservoir can be controlled and/or regulated by means of the at least one pre-conditioning valve.

The device can be configured an arranged such that the amount or the mass of gas fed into the first liquid reservoir is controllable via the at least one pre-conditioning valve. The device can be configured and arranged such that the amount or the mass of gas fed into the first liquid reservoir is regulatable via the at least one pre-conditioning valve.

According to an embodiment, the at least one pre-conditioning valve can be configured to control the priming time, i.e. the duration the aqueous liquid is primed.

Advantageously, the injection of gas in the first liquid container, particularly the priming of the aqueous liquid is easily regulatable by use of the at least one pre-conditioning valve.

According to an embodiment, the first flow control unit comprises a first pre-conditioning valve and a second pre-conditioning valve, wherein the first pre-conditioning valve and the second pre-conditioning valve are arranged in series, such that the storage section is delimited by the first pre-conditioning valve and the second pre-conditioning valve, particularly wherein the first pre-conditioning valve is arranged and configured to open and/or close the entrance of the storage section, and, particularly, wherein the second pre-conditioning valve is arranged and configured to open and/or close the exit of the storage section.

In an embodiment, the device comprises two valves, particularly two pre-conditioning valves, in series arranged between the pressure reducer and the first liquid container, e.g. the flow or volume of water, thereby forming a known volume of CO₂ to be mixed with the volume of water upon opening of the valve closest to the volume of water. In an embodiment, the device comprises the first and the second pre-conditioning valves arranged in series between the pressure reducer and the first liquid container, thereby forming a known volume of CO₂ to be mixed with the volume of water in the first liquid container upon opening of the pre-conditioning valve arranged and configured to open and/or close the exit of the storage section.

In an embodiment, the first pre-conditioning valve is arranged at the entrance of the storage section and configured to open and/or close the entrance, such that the first pre-conditioning valve can regulate the amount of gas entering the storage section.

In an embodiment, the second pre-conditioning valve is arranged at the exit of the storage section and configured to open and/or close the exit, such that the second pre-conditioning valve can regulate the amount of gas leaving the storage section.

The first pre-conditioning valve can be controllable. The second pre-conditioning valve can be controllable.

In an embodiment, the first flow control unit is configured to be in a first state and in a second state. In the first state, the first pre-conditioning valve can be open and the second pre-conditioning valve can be closed. In the first state, the storage section can be filled with gas via the entrance. In the second state, the first pre-conditioning valve can be closed and the second pre-conditioning valve can be opened. In the second state, the gas stored in the storage section can flow out of the storage section via the exit.

In an embodiment, the device is configured such that it can change from the first state to the second state and from the second state to the first state multiple times, particularly multiple times within a pre-determined period of time.

In an embodiment, the first flow control unit is configured to be in the first state, in the second state and in a third state. In the third state, the first and the second pre-conditioning valves can be closed. The amount of gas in the storage section can remain constant in the third state.

In an embodiment, the storage section is configured such that the amount of gas required for priming can be stored in the storage section. For priming, the first flow control unit can be changed from the first state or the third state to the second state. The pre-defined amount of gas previously stored in the storage section can flow from the storage section to the first liquid container.

In an embodiment, the storage section is configured such that a portion of the amount of gas required for priming can be stored in the storage section. For priming, the first flow control unit can be changed from the first state or the third state to the second state and back to the first state multiple times, such that multiple portions of the amount of gas can flow from the storage section to the first liquid container.

An advantage is that the amount or the volume of gas, particularly CO₂, provided to the first liquid container can easily be regulated by the first flow control unit. The volume of gas entering the first liquid container for priming can easily be adjusted depending on the requirements for pre-conditioning.

Advantageously, the injection of gas in the first liquid container, particularly the priming of the aqueous liquid is easily regulatable by use of the first and the second pre-conditioning valve.

An embodiment is characterised in that the device comprises at least one flow restrictor, wherein the at least one flow restrictor is comprised in the first flow control unit and/or in the gas providing unit, particularly in the pressure reducer or downstream of the pressure reducer.

In the context of this application and with respect to the first gas line, the wording upstream means closer to the gas providing unit. In the context of this application and with respect to the first gas line, the term downstream means more distant to the gas providing unit.

The flow restrictor can be a capillary tube. In an embodiment, the flow restrictor is a calibrated orifice. In an embodiment, the flow restrictor comprises or consists of a plurality of calibrated orifices. The flow restrictor can be an orifice plate.

In an embodiment, the flow restrictor is comprised in the pressure reducer.

According to an embodiment, the first flow control unit comprises one flow restrictor and one pre-conditioning valve. The flow restrictor and the pre-conditioning valve can be arranged in series. According to an embodiment, the flow restrictor is arranged upstream of the pre-conditioning valve. According to an embodiment, the flow restrictor is arranged downstream of the pre-conditioning valve.

In an embodiment, the flow restrictor is configured and arranged to restrict the flow of the gas entering the storage section. In an embodiment, the flow restrictor is configured and arranged to restrict the flow of the gas, particularly the amount or the volume of gas, passing the storage section. The flow restrictor can be configured and arranged to restrict the amount or the volume of gas, passing the storage section, when the pre-conditioning valve is in open state.

The device can be arranged and configured such that mixing the CO₂ “stored” between the flow restrictor and the second pre-conditioning valve will happen fast and one can adjust the flow restrictor such that the amount of extra CO₂ flowing through it while the pre-conditioning valve is open is negligible. The flow restrictor can be integrated in an outlet of the pressure reducer.

Advantageously, the complexity of the device is reduced when a flow restrictor is used. The costs of the device are advantageously reduced while remaining the functionality.

In an embodiment, the at least one flow restrictor is arranged and configured to restrict a gas flow at the entrance and/or at the exit of the storage section.

The flow restrictor can be arranged and configured to restrict the flow of gas passing the first gas line. The flow restrictor can be arranged and configured to restrict the flow of gas entering storage section.

In an embodiment, the device comprises a pre-conditioning valve at the exit of the storage section and a flow restrictor at the entrance of the storage section. The flow restrictor can be configured and arranged such, when the pre-conditioning valve is in its open state, the additional flow of gas entering the storage section is neglectable.

By means of the flow restrictor, the costs of the device are advantageously reduced.

In an embodiment, the device comprises a second flow control unit, wherein the second flow control unit comprises at least one carbonation valve configured to open and/or close the second gas line.

The carbonation valve can be a normally-closed valve. The carbonation valve can be a low-pressure valve.

The second flow control unit can be configured to regulate the amount of gas passing the second gas line. In particular, the second flow control unit can be configured to regulate the amount of gas to be injected into the second liquid container for treating the aqueous liquid, particularly to carbonate the aqueous liquid such that sparkling aqueous liquid is generated.

The second flow control unit can be controllable.

According to an embodiment, the second gas line comprises a nozzle, wherein the nozzle is arranged and configured to be insertable in the second liquid container, when the second liquid container is provided.

In an embodiment, the nozzle has an elongated shape. The nozzle can comprise a tip. Along its longitudinal axis, the nozzle can have a length between 60 mm and 120 mm. According to an embodiment, the nozzle has a length of 100 mm. At the tip of the nozzle, the nozzle can have a diameter between 5 mm and 15 mm. In an embodiment, the diameter at the tip of the nozzle is 12 mm.

In an embodiment, the nozzle is configured such that the tip is insertable in the aqueous liquid, when the second liquid container is filled with the aqueous liquid. In an embodiment, the nozzle is configured such that the tip is insertable in the aqueous liquid, when the second liquid container is provided and filled with the aqueous liquid.

In an embodiment, the nozzle comprises two outlet openings, wherein the nozzle is configured such that the gas can stream out of the second gas line via the nozzle, particularly via the two outlet openings, when the gas passes the second gas line.

The two outlet openings can be through-openings.

The two outlet openings can have a circular shape. The diameter of each of the two outlet openings can be between 0.2 mm and 1.5 mm. In an embodiment, the two outlet openings have the same diameter. In an embodiment, the diameter of each of the two outlet openings is 0.9 mm.

The distance between the two outlet openings can be between 3 mm and 10 mm. In an embodiment, the distance between the two outlet openings is 4.5 mm.

Via the outlet openings, gas can flow from second gas line into the second liquid container, when nozzle is inserted in second liquid container. Particularly, via the two outlet openings, gas can flow from second gas line into the aqueous liquid residing in the second liquid container, when nozzle is inserted in the aqueous liquid.

The gas flow can be increased compared to a flow through a single outlet opening. A greater volume of gas can pass the nozzle comprising two outlet openings compared to a nozzle comprising a single outlet opening. The two outlet openings can be arranged and configured to keep the velocity of the jet of gas, particularly CO₂ at a sufficient level while delivering more mass of CO₂ for a given time.

Despite the reduced pressure of the gas, the gas can quickly be fed in the second liquid container, i.e. the aqueous liquid can be carbonated quickly, due to the increased flow through the two outlet openings.

Advantageously, the time required to carbonate the aqueous liquid, particularly to generate sparkling water, is short and user-friendly.

In an embodiment, the conditioning unit comprises at least one medium, wherein the medium is configured to add at least one substance to the aqueous liquid, particularly the pre-conditioned aqueous liquid, particularly by dissolution of the substance in the aqueous liquid, when the aqueous liquid is brought in contact with the medium, particularly wherein the medium comprises at least one mineral salt, particularly a mineral salt comprising calcium, magnesium and/or sodium.

The medium can comprise a mineral salt of low solubility in aqueous liquid, particularly water. The medium can comprise a mineral salt whose solubility is increased in an acidified aqueous liquid.

The conditioning unit can comprise calcium carbonate. The conditioning unit can comprise magnesium oxide.

The conditioning unit can be a mineral cartridge.

The conditioning unit can be configured such that the aqueous liquid is enhanced by the conditioning unit.

The device can be configured such that the conditioning unit is easily removable from the device. The device can be configured such that the conditioning unit is easily insertable in the device. Advantageously, the conditioning device can be exchanged in a fast and user-friendly manner.

The conditioning unit can be a volume of minerals. The volume of minerals can be positioned between the first liquid container and the second liquid container such that the water acidified in the first liquid container can partly dissolve minerals from the volume of minerals, thereby producing still mineralized water. The still mineralized water can then be conducted to the second liquid container for carbonation. The still mineralized water conducted to the second liquid container can be consumed directly as still mineralized water or it can be carbonated to be consumed as sparkling mineralized water.

According to an embodiment, the device comprises a pump configured to move the aqueous liquid from the first liquid container to the second liquid container via the fluid line.

The pump can be configured to move the aqueous liquid from the input section to the first liquid container. The pump can be configured to move the aqueous liquid from the first liquid container to the conditioning unit via the fluid line. The pump can be configured to move the aqueous liquid from the conditioning unit to the second liquid container.

In an embodiment, the pump is configured to move the aqueous liquid from the input section to the first liquid container. In an embodiment, the pump is configured to move the aqueous liquid from the source of the aqueous liquid to the first liquid container, particularly via the input section.

According to an embodiment, the pump is arranged and configured to move the aqueous liquid from the input section to the first liquid container and from the first liquid container to the second liquid container via the conditioning unit.

In an embodiment, the pump is a hydraulic pump.

In an embodiment, the pump is closer to a source of the aqueous liquid than the first liquid container. The source of the aqueous liquid can be a tank.

A second aspect of the invention is related to a method for treating an aqueous liquid, particularly using a device according to the invention. The method comprises the steps of:
a) providing gas in a gas providing unit,
b) providing the aqueous liquid in a first liquid container,
c) moving the gas from the gas providing unit via a first gas line,
d) feeding the gas through the first gas line in the first liquid container containing the aqueous liquid, generating pre-conditioned aqueous liquid,
e) directing the aqueous liquid, particularly the pre-conditioned aqueous liquid, from the first liquid container to the conditioning unit via a fluid line, particularly generating conditioned aqueous liquid,
f) providing a second liquid container,
g) directing the aqueous liquid, particularly the conditioned aqueous liquid, from the conditioning unit to the second liquid container via a fluid line,
h) moving the gas from the gas providing unit via a second gas line, and
i) feeding the gas via the second gas line into the second liquid container containing the aqueous liquid, particularly the conditioned aqueous liquid, particularly generating carbonated aqueous liquid.

The pre-conditioned aqueous liquid can be moved from the first liquid container to the conditioning unit comprising at least one medium, wherein at least one substance is added to the pre-conditioned aqueous liquid, when the pre-conditioned aqueous liquid is brought in contact with the at least one medium.

In an embodiment, the first gas line is opened by opening at least one pre-conditioning valve, such that the gas can pass the first gas line and flow in the first liquid reservoir.

The first gas line can be closed by closing at least one pre-conditioning valve.

The second liquid container can be pressurised by injecting the gas into the second liquid container. The second liquid container can be pressurised by injecting the gas and the aqueous liquid, particularly the pre-conditioned aqueous liquid, more particularly the conditioned aqueous liquid, contained in the second liquid reservoir can be carbonated, particularly wherein carbonated aqueous liquid is generated.

The second gas line can be opened by opening at least one carbonation valve, such that the gas can pass the second gas line and be fed into the second liquid container.

The second gas line can be closed by closing the at least one carbonation valve.

According to an embodiment, gaseous CO₂ is fed into the first liquid container, particularly 0.2 g CO₂ per liter aqueous liquid to 2 g CO₂ per liter aqueous liquid, more particularly 0.5 g CO₂ per liter aqueous liquid to 1 g CO₂ per liter aqueous liquid, generating pre-conditioned aqueous liquid.

According to an embodiment, gaseous CO₂ is fed into the second liquid container, particularly 5 g CO₂ per liter aqueous liquid to 35 g CO₂ per liter aqueous liquid, more particularly 8 g CO₂ per liter aqueous liquid to 20 g CO₂ per liter aqueous liquid, generating carbonated aqueous liquid, particularly sparkling water.

In the following, further features, advantages and embodiments of the present invention are explained with reference to the Figures, wherein

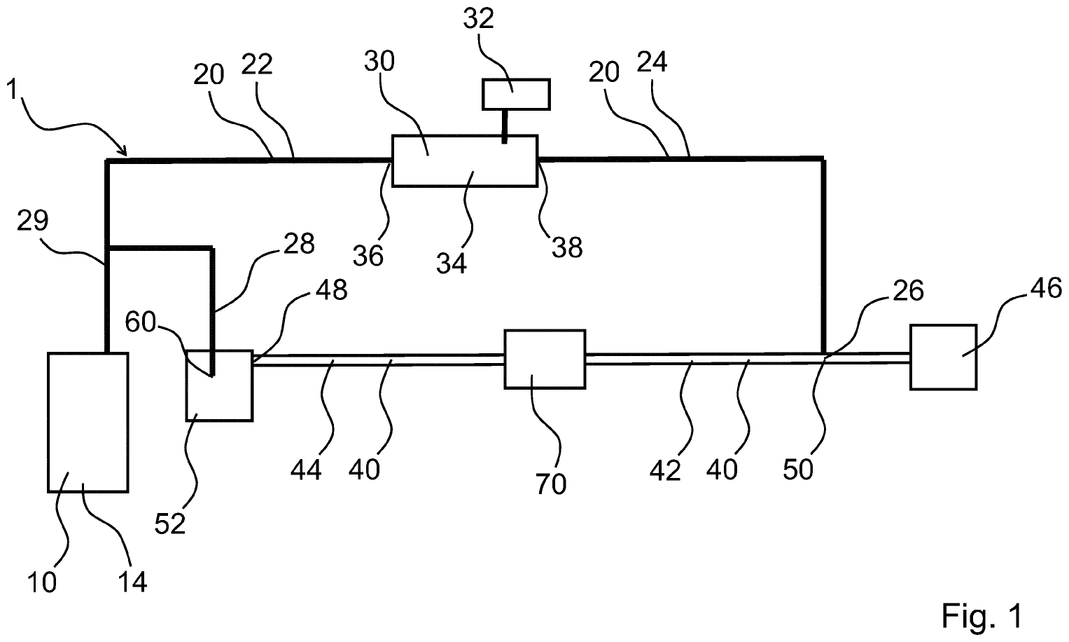

FIG. 1 shows a schematic diagram of an embodiment of the device according to the invention,

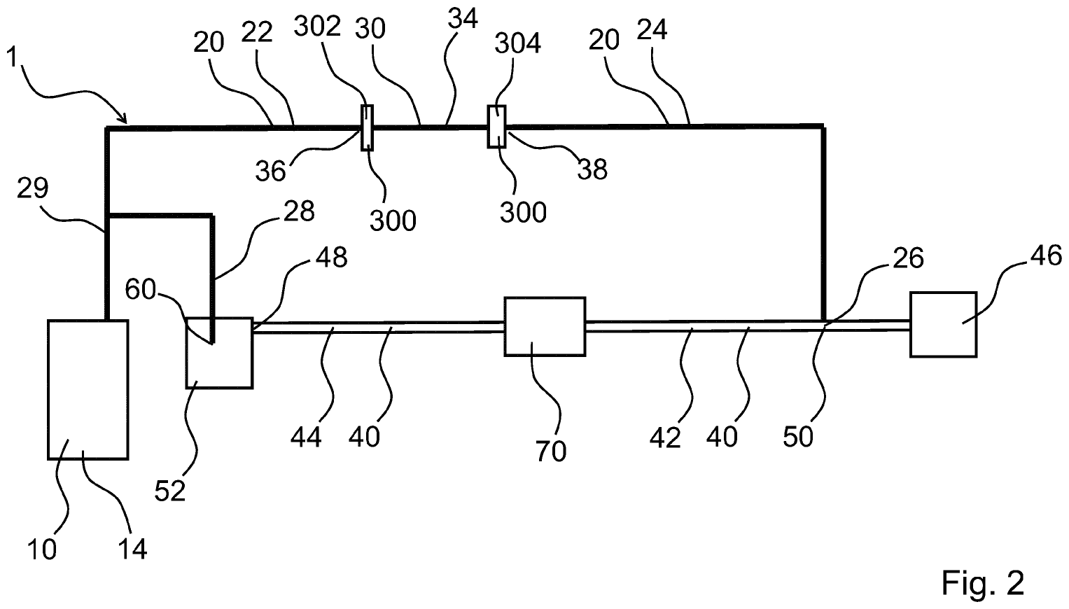

FIG. 2 shows a schematic diagram of an embodiment of the device according to the invention, wherein the device comprises a first and a second pre-conditioning valve,

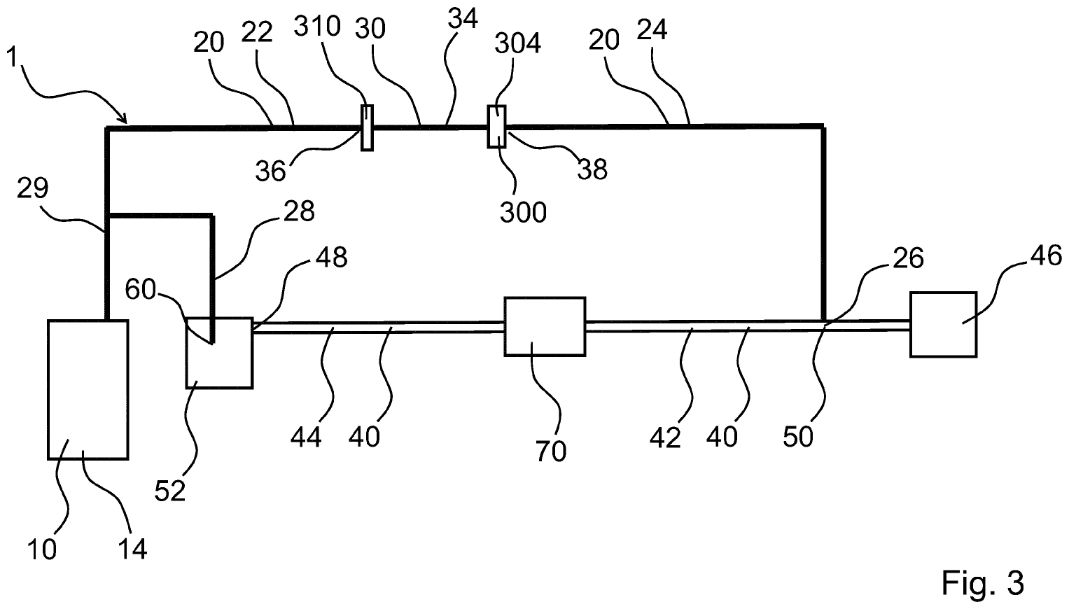

FIG. 3 shows a schematic diagram of an embodiment of the device according to the invention, wherein the device comprises a first flow restrictor and a second pre-conditioning valve,

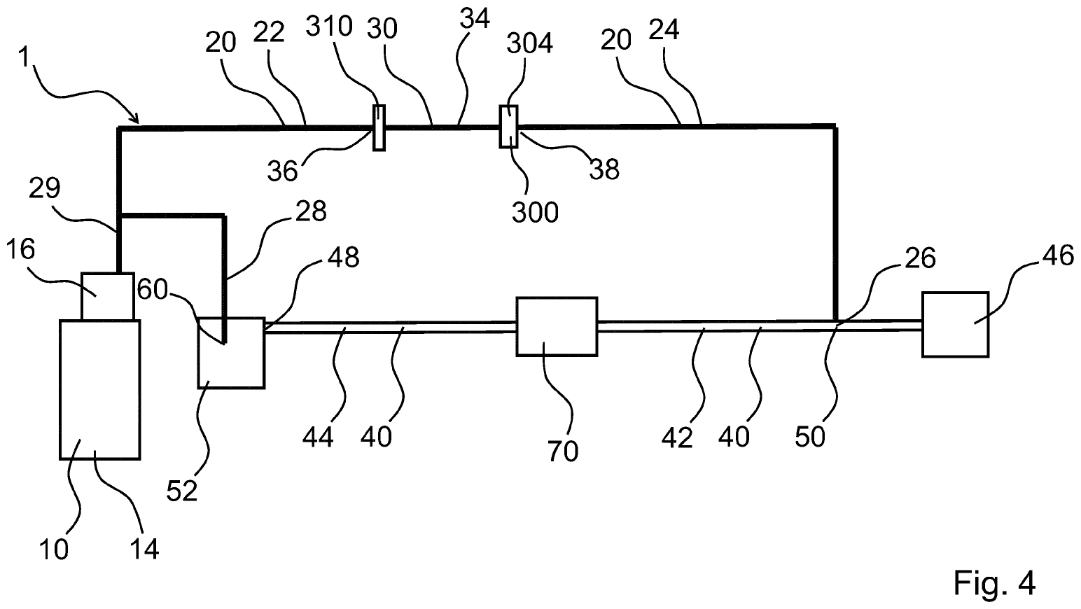

FIG. 4 shows a schematic diagram of an embodiment of the device according to the invention comprising pressure reducer, a first flow restrictor and a second pre-conditioning valve,

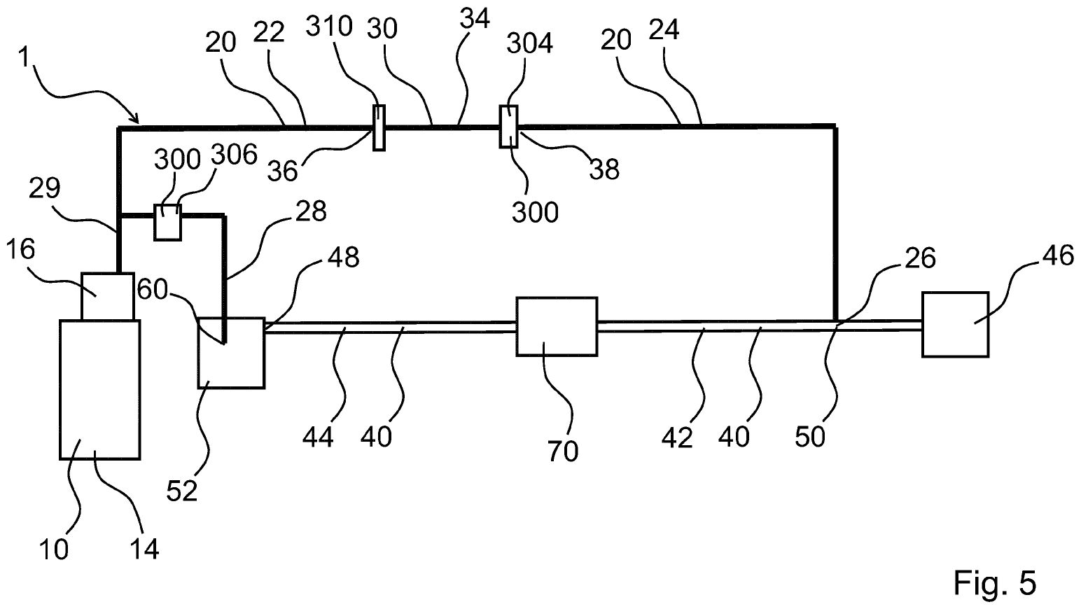

FIG. 5 shows a schematic diagram of an embodiment of the device according to the invention comprising pressure reducer, a first flow restrictor, a second pre-conditioning valve and a carbonation valve,

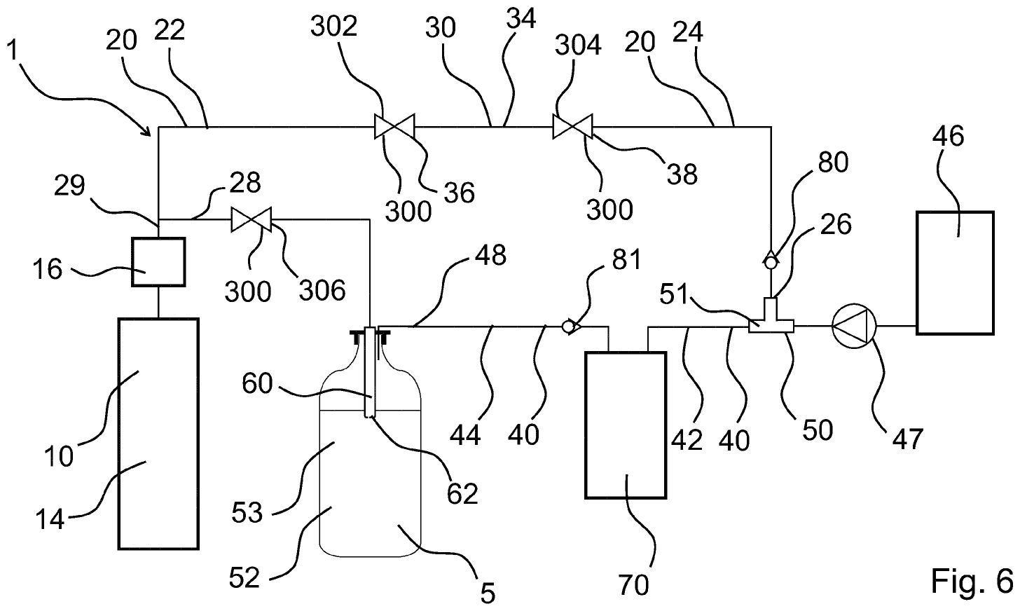

FIG. 6 shows a schematic diagram of an embodiment of the device according to the invention comprising a pressure reducer, a first and a second pre-conditioning valve and a carbonation valve,

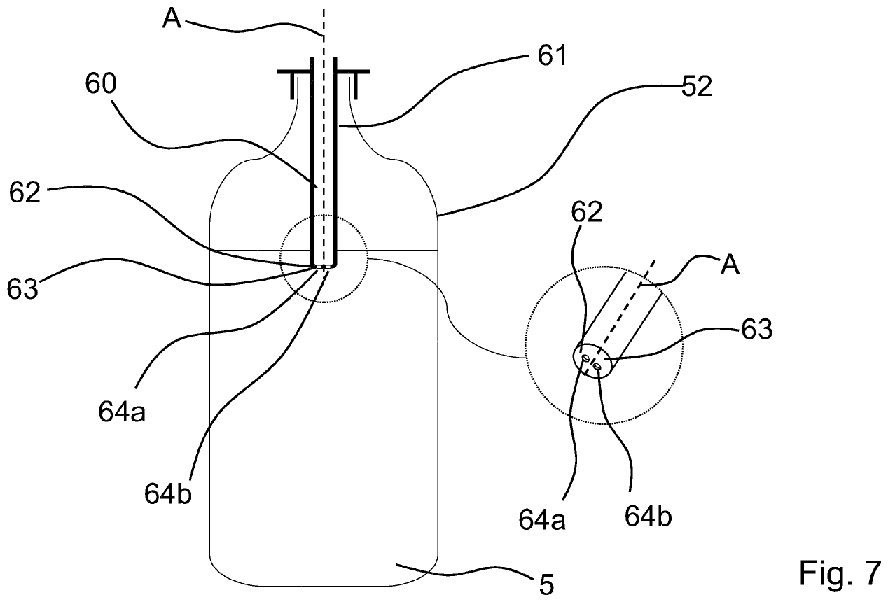

FIG. 7 illustrates the nozzle, wherein the inlet shows details of the tip of the nozzle, and

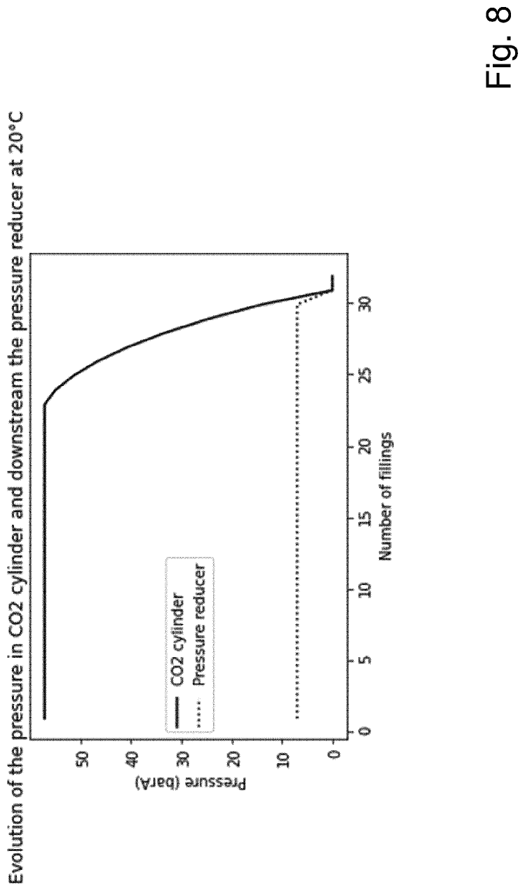

FIG. 8 illustrates the temporal development of the pressure in the gas providing unit and of the pressure downstream of the pressure reducer.

FIGS. 1-6, each show a schematic diagram of an embodiment of the device 1. The device 1 can comprise a gas providing unit 10. The gas providing unit 10 can be configured to store a gas, particularly CO₂. The gas providing unit 10 can comprise a gas cartridge 14. The gas providing unit 10 can comprise a pressure reducer 16 (FIG. 4, FIG. 5, FIG. 6).

The device 1 can comprise a first gas line 20 and a second gas line 28. The device 1 can be configured such that the gas can flow from the gas providing unit 10 via the first gas line 20 towards the outlet section 26, when the gas is delivered from the gas providing unit 10. The device 1 can be configured such that the gas can flow from the gas providing unit 10 via the second gas line 28 towards the nozzle 60, when the gas is delivered from the gas providing unit 10.

According to an embodiment, the device 1 comprises a shared gas line 29, wherein the shared gas line 29 furcates in the first gas line 20 and the second gas line 28. In an embodiment, the device comprises a shared gas line 29, wherein the first gas line 20 and the second gas line 28 originate from the shared gas line 29. In an embodiment, the shared gas line 29 is a section of the first gas line 20. In an embodiment, the shared gas line 29 is a section of the second gas line 28.

The first gas line 20 can comprise a first section 22. The first gas line 20 can comprise a second section 24. The gas providing unit 10 can be connected with the first gas line 20, particularly with the first section 22 of the gas line 20. In an embodiment, the first gas line 20 is connected to the gas providing unit 10 via the shared gas line 29.

The device 1 can comprise a first flow control unit 30. The first section 22 of the first gas line 20 can be connected with the first flow control unit 30. Particularly, the first section 22 of the first gas line 20 can be connected fluidically with the first flow control unit 30. The second section 24 of the first gas line 20 can be connected, particularly connected fluidically, with the first flow control unit 30. In an embodiment, the first flow control unit 30 is arranged and configured to connect, particularly to connect fluidically, the first section 22 of the first gas line 20 and the second section 24 of the first gas line 20.

The first flow control unit 30 can comprise an entrance 36. The first flow control unit 30 can comprise an exit 38. The entrance 36 can be arranged upstream of the exit 38. In the context of the application and with respect to the first gas line 20 and/or the flow of the gas through the first gas line 20, this means that the entrance 36 of the first flow control unit 30 can be arranged closer to the gas providing unit 10 than the exit 38 of the first flow control unit 30.

The first flow control unit 30 can comprise a storage section 34. The storage section 34 can comprise an inner space. The storage section 34, particularly the inner space of the storage section 34, can be connected fluidically with the first gas line 20.

The first section 22 of the first gas line 20 can be connected to the entrance 36. The second section 24 of the first gas line 20 can be connected to the exit 38 of the first flow control unit 30. The storage section 24 can be formed by the first gas line 20. The storage section 24 can comprise a pre-defined volume.

According to an embodiment, the device 1 comprises a valve 300. The valve 300 can be in an open state. The valve 300 can be in a closed state. The valve can be a carbonation valve 306 (FIG. 5, FIG. 6). In an embodiment, the valve 300 is a pre-conditioning valve 302, 304 (FIG. 2-FIG. 6).

The device can comprise a carbonation valve 306. The carbonation valve 306 can be arranged and configured to open and/or close the second gas line 28 (FIG. 5, FIG. 6).

In an embodiment, the device 1 comprises a pre-conditioning valve 302, 304 (FIG. 2-FIG. 6). In an embodiment, the device 1 comprises a first pre-conditioning valve 302 and a second pre-conditioning valve 304 (FIG. 2, FIG. 6).

The first pre-conditioning valve 302 can be arranged at the entrance 36 of the storage section 30. The second pre-conditioning valve 304 can be arranged at the exit 38 of the storage section 30 (FIG. 2, FIG. 6).

In an embodiment the first pre-conditioning valve 302 is configured to open and/or close the first gas line 20, particularly to open and/or close the entrance 36 of the storage section 30. According to an embodiment, via the first pre-conditioning valve 302 the amount of gas entering the storage section 24 is controllable.

The first pre-conditioning valve 302 can be arranged such that a pre-defined volume of gas can be stored in the storage section 30. The position of the first pre-conditioning valve 302 can be selected to have a pre-determined volume of gas that can be stored in the storage section 30.

In an embodiment the second pre-conditioning valve 304 is configured to open and/or close the first gas line 20, particularly to open and/or close the exit 38 of the storage section 30. According to an embodiment, via the second pre-conditioning valve 304 the amount of gas leaving the storage section 24 is controllable.

The second pre-conditioning valve 304 can be arranged such that a pre-defined volume of gas can be stored in the storage section 30. The position of the second pre-conditioning valve 302 can be selected to have a pre-determined volume of gas that can be stored in the storage section 30.

In particular, the first pre-conditioning valve 302 and the second pre-conditioning valve 304 can be arranged such that a pre-defined volume of gas can be stored in the storage section 30, particularly between the first pre-conditioning valve 302 and the second pre-conditioning valve 304. The position of the first pre-conditioning valve 302 and the position of the second pre-conditioning valve 302 can be selected to have a pre-determined volume of gas that can be stored between the first pre-conditioning valve 302 and the second pre-conditioning valve 304.

In an embodiment, the device 1 comprises a flow restrictor 310 (FIG. 3, FIG. 4, FIG. 5). The flow restrictor 310 can be arranged at the entrance 36 of the storage section 30. In an embodiment, the flow restrictor 310 is arranged at the entrance 36 and the second pre-conditioning valve 304 is arranged at the exit 38 of the storage section 30.

In an embodiment, the device 1 comprises a first control unit 32 (FIG. 1). The first control unit 32 can be configured to control at least one valve 300, particularly at least one pre-conditioning valve 302, 304, particularly the first pre-conditioning valve 302 and/or the second pre-conditioning valve 304. The first control unit 32 can be configured to regulate the state of the particular valve 300. The first control unit 32 can be configured to regulate the state of the first pre-conditioning valve 302. The first control unit 32 can be configured to regulate the state of the second pre-conditioning valve 304.

The first control unit 32 can be configured such that via the first control unit 32, the state of the first pre-conditioning valve 302 can be changed from the open state to the closed state and/or from the closed state to the open state. The first control unit 32 can be configured such that via the first control unit 32, the state of the second pre-conditioning valve 304 can be changed from the open state to the closed state and/or from the closed state to the open state.

In an embodiment, the first gas line 20 comprises an outlet 26. In particular, the second section 24 of the first gas line 20 can comprise the outlet 26.

The device 1 can be arranged and configured such that a gas can flow from the gas providing unit 10 through the first gas line 20. Particularly, the device 1 can be arranged and configured such that the gas can flow from the gas providing unit 10 via the first flow control unit 30 to the outlet 26. The gas can leave the first gas line 20 via the outlet 26. In an embodiment, the device 1 is configured such that the gas can be ejected multiple times via the outlet 26. A first check valve 80 can be arranged in the first gas line 20, particularly in the second section 24 of the first gas line 20 (FIG. 6). The first check valve 80 can be arranged in the first liquid container 50.

The device 1 can comprise a fluid line 40. The fluid line 40 can comprise a first section 42. The fluid line 40 can comprise a second section 44. The device 1 can comprise a conditioning unit 70. The conditioning unit 70 can be configured and arranged such that the conditioning unit 70 connects the first section 42 of the fluid line 40 and the second section 44 of the fluid line 40.

The fluid line 40, particularly the first section 42 of the fluid line 42 can be connected with a first liquid container 50. In an embodiment, the fluid line 40, particularly the first section 42 of the fluid line 42 comprises the first liquid container 50. The first liquid container 50 can be formed by the fluid line 40. In an embodiment, the first liquid container 50 is a T-junction 51 (FIG. 6). The first section 42 of the fluid line 40 can connect the first liquid container 50 and the conditioning unit 70.

The first gas line 20 can be connected with the first liquid container 50 such that, when the gas flows out of the first gas line 20 via the outlet 26, the gas can enter the first liquid container 50. The first gas line 20 can be connected fluidically with the first liquid container 50.

A second liquid container 52 can be provided to the device 1. In an embodiment, the second liquid container 52 is a bottle 53 (FIG. 6). The device 1 can comprise a second liquid container 52. The second liquid container 52 can be connected with the conditioning unit 70 via the fluid line 40, particularly the second section 44 of the fluid line 40. In an embodiment, the second liquid container 52 is reversibly connectable to the fluid line 40, particularly reversibly connectable to the second section 44 of the fluid line 40.

In an embodiment, the fluid line 40, particularly the second section 44 of the fluid line 40, comprises a fluid outlet 48. The fluid outlet 48 can be insertable in the second liquid container 52. The fluid outlet 48 can be connectable to the second liquid container 52. The fluid outlet 48 can be connected to the second liquid container 52. In an embodiment, the fluid line 40, particularly the second section 44 of the fluid line 40, comprises a second check valve 81.

The device 1 can be configured such that via the fluid line 40, the aqueous liquid can be moved from the first liquid container 50 via the conditioning unit 70 to the second liquid container 52. The aqueous liquid can be moved from the fluid line 40 to the second liquid container 52 via the fluid outlet 48.

In an embodiment, the aqueous liquid can be moved by a pump 47 (FIG. 6). In an embodiment, the pump 47 is arranged upstream of the first liquid container 50. In the context of the application and with respect to the fluid line 40, the term “upstream” means “closer to the source of the aqueous liquid 46”.

The conditioning unit 70 can comprise a mineralisation unit. The conditioning unit 70 can comprise the second check valve 81 (FIG. 6). The second check valve 81 can be configured to prevent in influx of gas coming from the second liquid container 52 in the conditioning unit 70 and/or the pump 47.

The device 1 can comprise a second gas line 28. The second gas line 28 can connect the gas providing unit 10 and the second liquid container 52. In an embodiment, the second gas line 28 is insertable in the second liquid container 52. In an embodiment, the second gas line 28 is reversibly connectable with the second liquid container 52.

The device 1 can comprise a nozzle 60 (FIG. 6, FIG. 7). The nozzle 60 can be connected to the second gas line 28. The second gas line 28 can comprise the nozzle 60.

In an embodiment, when the second liquid container 52 is filled with the aqueous liquid 5, the nozzle 60 is insertable in the second liquid container 52 such that the nozzle 60, particularly the tip 62 of the nozzle 60, protrudes into the aqueous liquid 5, i.e. dips into the aqueous liquid 5 (FIG. 6, FIG. 7).

In an embodiment, the carbonation valve 306 is arranged and configured to open and/or close the second gas line 28 (FIG. 5, FIG. 6).

According to an embodiment, the gas providing unit 10 comprises a pressure reducer 16 (FIG. 4, FIG. 5, FIG. 6). In an embodiment, the shared gas line 29 is connected to the pressure reducer 16. The first gas line 20 can be connected with the pressure reducer 16. The second gas line 28 can be connected with the pressure reducer 16.

According to an embodiment, the device 1 is configured such that the storage section 30 can be filled with gas, emptied and refilled with gas multiple times, particularly such that the storage section 30 can release the pre-defined volume of gas multiple time at equal time intervals.

For filling the storage section 30 with gas, the first pre-conditioning valve 302 can be open and the second pre-conditioning valve 304 can be closed. The gas can flow into the storage section 30 and remains there. For emptying, the second pre-conditioning valve 304 can be opened. In particular, the first pre-conditioning valve 302 is closed when the gas leaves the storage section 30 via the exit 38 such that no additional gas passes the storage section. After emptying, the second pre-conditioning valve 304 can be closed and the first pre-conditioning valve can be open such that the storage section 30 can be filled with gas again.

According to an embodiment, the device is configured to fed 0.4 g CO₂ in 1 l of aqueous liquid, particularly water, flowing in one minute from the source of the aqueous liquid 46, through the first liquid container 50, to the conditioning unit 70. The pre-defined volume of gas stored between the first pre-conditioning valve 302 and the second pre-conditioning valve 304 can be 20 mg. The first pre-conditioning valve 302 and the second pre-conditioning valve 304 can be controlled such that the first pre-conditioning valve 302 is opened to fill the storage section 30 with the gas and then is closed, followed by the opening of the second pre-conditioning valve 304 until the gas is mixed. In an embodiment, the second pre-conditioning valve 304 is opened for 1 s. Then the second pre-conditioning valve 304 is closed. This sequence of opening and/or closing the first pre-conditioning valve 302 and/or second pre-conditioning valve 304 is repeated 20 times. In an embodiment, the sequence of events is repeated 20 times at equally spaced time points, for example regularly every 3 s.

In FIG. 7, an embodiment of the nozzle 60 is shown, wherein the nozzle 60 is inserted in the second liquid container 52. The nozzle 60 can comprise an elongated body 61. The elongated body 61 can extend along a longitudinal axis A. The nozzle 60 can comprise a tip 62. The tip 62 is shown in more detail in the inset of FIG. 7.

The nozzle 60 can comprise two outlet openings 64a, 64b (FIG. 7, particularly inset FIG. 7). Each of the outlet openings 64a, 64b can have a circular shape. The outlet openings 64a, 64b can be arranged at the tip 62 of the nozzle 60. The outlet openings 64a, 64b can be arranged at the front end 63 of the nozzle 60.

FIG. 8 illustrates the drop of the first pressure which is the pressure downstream the pressure reducer (dotted line) and of the second pressure, which is the pressure in the gas cartridge, i.e. in the CO₂ cylinder (solid line) dependent on the number of fillings, i.e. number of treatments. The first pressure can be 8 bar. The second pressure can be 56 bar. The first pressure can remain constant for a higher number of cycles than the second pressure. The carbonation and the pre-conditioning can be longer stable over time, thereby advantageously improving the user experience. While the second pressure can decrease after about 23 fillings, the first pressure can remain constant for about 30 cycles. In an embodiment, the second pressure remains constant for the starting time, i.e. the first fillings, because CO₂ is stored in two phases, i.e. liquid and gaseous, in the CO₂ cylinder.

1. A device for treating an aqueous liquid, comprising
a gas providing unit, providing a gas at a first pressure,
a first gas line connecting the gas providing unit and a first liquid container, such that the gas is feedable in the first liquid container via the first gas line, such that when the first liquid container contains the aqueous liquid, the aqueous liquid can be pre-conditioned,
a conditioning unit,
a fluid line connecting the first liquid container with a second liquid container, when the second liquid container is provided, wherein the fluid line comprises a first section and a second section, wherein the first section of the fluid line connects the first liquid container and the conditioning unit and the second section of the fluid line connects the conditioning unit and the second liquid container,
a second gas line connecting the gas providing unit and the second liquid container, when the second liquid container is provided, such that the gas is feedable in the second liquid container via the second gas line, such that when the second liquid container contains the aqueous liquid, particularly the aqueous liquid previously pre-conditioned in the first liquid container, the gas can be injected in the aqueous liquid,
wherein the device is arranged and configured such that the gas is feedable in the aqueous liquid upstream of the conditioning unit via the first gas line and downstream of the conditioning unit via the second gas line.

2. The device according to claim 1, characterised in that the gas providing unit comprises a gas reservoir containing a pressurised gas at a second pressure and a pressure reducer connected with the gas reservoir, wherein the pressure reducer is configured to reduce the pressure from the second pressure to the first pressure, such that the gas providing unit provides the gas at the first pressure.

3. The device according to claim 1, characterised in that the device comprises at least one valve, wherein the at least one valve is arranged and configured to open and/or to close the first gas line and/or the second gas line, particularly wherein the at least one valve is a low-pressure valve.

4. The device according to claim 1, characterised in that the device comprises a first flow control unit, wherein the first flow control unit is configured to regulate the amount of gas passing the first gas line.

5. The device according to claim 4, characterised in that the first flow control unit comprises a storage section configured to store a predefined volume of gas, wherein the storage section comprises an entrance and an exit, wherein the entrance and/or the exit are configured to be opened and/or closed.

6. The device according to claim 4, characterised in that the first flow control unit comprises at least one pre-conditioning valve, wherein the at least one pre-conditioning valve is configured to open and/or close the first gas line, in particular configured to open and/or close the entrance and/or the exit of the storage section.

7. The device according claim 5, characterised in that the first flow control unit comprises a first pre-conditioning valve and a second pre-conditioning valve, wherein the first pre-conditioning valve and the second pre-conditioning valve are arranged in series, such that the storage section is delimited by the first and the second pre-conditioning valve, particularly wherein the first pre-conditioning valve is arranged and configured to open and/or close the entrance of the storage section, and, particularly, wherein the second pre-conditioning valve is arranged and configured to open and/or close the exit of the storage section.

8. The device according to claim 1, characterised in that the device comprises at least one flow restrictor, wherein the at least one flow restrictor is comprised in the first flow control unit and/or in the gas providing unit, particularly in the pressure reducer or downstream of the pressure reducer.

9. The device according to claim 8, characterised in that the at least one flow restrictor is arranged and configured to restrict a gas flow at the entrance and/or at the exit of the storage section.

10. The device according to claim 1, characterised in that the device comprises a second flow control unit, wherein the second flow control unit comprises at least one carbonation valve configured to open and/or close the second gas line.

11. The device according to claim 1, characterised in that the second gas line comprises a nozzle, wherein the nozzle is arranged and configured to be insertable in the second liquid container, when the second liquid container is provided.

12. The device according to claim 11, characterised in that the nozzle comprises two outlet openings, wherein the nozzle is configured such that the gas can stream out of the second gas line via the nozzle, particularly via the two outlet openings, when the gas passes the second gas line.

13. The device according to claim 1, characterised in that the conditioning unit comprises at least one medium, wherein the medium is configured to add at least one substance to the aqueous liquid, particularly the pre-conditioned aqueous liquid, particularly by dissolution of the substance in the aqueous liquid, when the aqueous liquid is brought in contact with the medium, particularly wherein the medium comprises at least one mineral salt, particularly a mineral salt comprising calcium, magnesium and/or sodium.

14. The device according to claim 1, characterised in that the device comprises a pump configured to move the aqueous liquid from the first liquid container to the second liquid container via the fluid line.

15. A method for treating an aqueous liquid, particularly using the device according to claim 1, comprising the steps of:
a) providing gas in a gas providing unit,
b) providing the aqueous liquid in a first liquid container,
c) moving the gas from the gas providing unit via a first gas line,
d) feeding the gas through the first gas line in the first liquid container containing the aqueous liquid, generating pre-conditioned aqueous liquid,
e) directing the aqueous liquid, particularly the pre-conditioned aqueous liquid, from the first liquid container to the conditioning unit via a fluid line, particularly generating conditioned aqueous liquid,
f) providing a second liquid container,
g) directing the aqueous liquid, particularly the conditioned aqueous liquid, from the conditioning unit to the second liquid container via a fluid line,
h) moving the gas from the gas providing unit via a second gas line, and
i) feeding the gas via the second gas line into the second liquid container containing the aqueous liquid, particularly the conditioned aqueous liquid, particularly generating carbonated aqueous liquid.
